(19) United States
(12) Patent Application Publication
(10) Pub. No.: US 2025/0022649 A1
(43) Pub. Date: Jan. 16, 2025

(54) ELECTRONIC COMPONENT

(71) Applicant: TDK Corporation, Tokyo (JP)

(72) Inventors: Noriyuki SAITO, Tokyo (JP); Tomoaki KAWADA, Tokyo (JP); Shigemitsu TOMAKI, Tokyo (JP); Misaki TABATA, Tokyo (JP); Riku TAKEDA, Tokyo (JP); Hiroshi SATOU, Tokyo (JP); Gaku ECHIGOYA, Tokyo (JP)

(73) Assignee: TDK Corporation, Tokyo (JP)

(21) Appl. No.: 18/768,491

(22) Filed: Jul. 10, 2024

(30) Foreign Application Priority Data
Jul. 11, 2023 (JP) 2023-113539

(51) Int. Cl. H01F 27/28

(52) U.S. Cl. CPC H01F 27/2847

(57) ABSTRACT

A coil component includes an element body, and a first coil conductor and a second coil conductor disposed in the element body, in which the conductor has, in a cross section orthogonal to an extending direction of the first coil conductor and the second coil conductor, a first end portion and a second end portion in a width direction viewed from the extending direction, the first end portion forms a first angle, the second end portion forms a second angle, and the first angle and the second angle are different.

### CROSS-REFERENCE TO RELATED APPLICATION

The present application claims priority from Japanese Patent Application No. JP 2023-113539 filed on Jul. 11, 2023, the content of which is incorporated herein by reference.

### TECHNICAL FIELD

The present disclosure relates to an electronic component.

### BACKGROUND

Patent Document 1 (Japanese Unexamined Patent Publication No. H7-22241) discloses an electronic component (inductor) including: a first magnetic substrate that is an insulator in which a coil groove is formed by a coil pattern having a predetermined shape, a conductor film is formed in the coil groove, a surface is planarized, and a conductor is formed only in the coil groove; and a second magnetic substrate that is an insulator bonded and fixed so as to cover the conductor of the first magnetic substrate. In the electronic component described in Patent Literature 1, the cross section of the conductor has a triangular shape or a trapezoidal shape.

### SUMMARY

An object of one aspect of the present disclosure is to provide an electronic component capable of increasing a frequency of a self-resonant frequency while obtaining a high Q factor.

(1) An electronic component according to an aspect of the present disclosure includes an element body, and a conductor disposed in the element body, in which the conductor has, in a cross section orthogonal to an extending direction of the conductor, a first end portion and a second end portion in a width direction viewed from the extending direction, the first end portion forms a first angle, the second end portion forms a second angle, and the first angle and the second angle are different.

In the electronic component according to an aspect of the present disclosure, the first end portion and the second end portion of the conductor form a first angle and a second angle, respectively, and the first angle and the second angle are different from each other. In this configuration, for example, a high Q factor can be obtained by increasing one of the first angle and the second angle. In addition, in the electronic component, for example, stray capacitance between the conductor and another component can be reduced by reducing the other angle of the first angle and the second angle. As a result, in the electronic component, the self-resonant frequency can be increased.

(2) In the electronic component according to (1), the first angle may be larger than the second angle. In this configuration, a high Q factor can be obtained.

(3) In the electronic component according to (2), the first angle may be 60° or more. In this configuration, a high Q factor can be obtained.

(4) In the electronic component according to (2), the second angle may be less than 60°. In this configuration, stray capacitance between the conductor and another component can be reduced. As a result, in the electronic component, the self-resonant frequency can be increased.

(5) In the electronic component according to any one of (1) to (4), when a current flows through the conductor, the current distribution at the first end portion may be higher than the current distribution at the second end portion. In this configuration, a high Q factor can be obtained by making the first angle larger than the second angle.

(6) In the electronic component according to (2), the conductor has a first surface and a second surface connecting the first end portion and the second end portion, and at least one of the first surface and the second surface may be curved. In this configuration, the angle of the end portion can be reduced (pointed) by curving the first surface and/or the second surface. As a result, the stray capacitance between the conductor and another component can be reduced. Therefore, in the electronic component, the self-resonant frequency can be increased.

(7) An electronic component according to an aspect includes an element body, and a conductor disposed in the element body, in which the conductor has, in a cross section orthogonal to an extending direction of the conductor, a first end portion and a second end portion in a width direction viewed from the extending direction, the first end portion has a first taper rate set based on a ratio between a thickness of the conductor and a first distance from an end of the first end portion to a position at a distance of ½ of the thickness in the width direction, the second end portion has a second taper rate set based on a ratio between the thickness of the conductor and a second distance from an end of the second end portion to a position at a distance of ½ of the thickness in the width direction, and the first taper rate and the second taper rate are different.

In the electronic component according to an aspect of the present disclosure, the first end portion and the second end portion of the conductor have a first taper rate and a second taper rate, respectively, and the first taper rate and the second taper rate are different from each other. In this configuration, for example, a high Q factor can be obtained by increasing the taper rate of one of the first taper rate and the second taper rate. In addition, in the electronic component, for example, the stray capacitance between the conductor and another component can be reduced by reducing the other of the first taper rate and the second taper rate. As a result, in the electronic component, the self-resonant frequency can be increased.

(8) In the electronic component according to (7), the first taper rate may be larger than the second taper rate. In this configuration, a high Q factor can be obtained.

(9) In the electronic component according to (8), the first taper rate may be 55% or more. In this configuration, a high Q factor can be obtained.

(10) In the electronic component according to (8), the second taper rate may be less than 55%. In this configuration, stray capacitance between the conductor and another component can be reduced. As a result, in the electronic component, the self-resonant frequency can be increased.

(11) In the electronic component according to any one of (7) to (10), when a current flows through the conductor, the current distribution at the first end portion may be higher than the current distribution at the second end portion. In this configuration, a high Q factor can be obtained by making the first taper rate larger than the second taper rate.

According to an aspect of the present disclosure, it is possible to increase the frequency of the self-resonant frequency while obtaining a high Q factor.

### BRIEF DESCRIPTION OF THE DRAWINGS

FIG. 1 is a perspective view of a coil component according to a first embodiment;

FIG. 2 is a perspective view of a coil of the coil component illustrated in FIG. 1;

FIG. 3 is a view illustrating a cross-sectional configuration taken along line III-III in FIG. 2;

FIG. 4 is a diagram for explaining an angle of a coil conductor;

FIG. 5 is a diagram for explaining a taper rate of a coil conductor;

FIG. 6 is a perspective view of a coil component according to a second embodiment;

FIG. 7 is a perspective view of the coil component illustrated in FIG. 6;

FIG. 8 is a view of the coil component illustrated in FIG. 6 as viewed from a main surface side;

FIGS. 9A, 9B, 9C, 9D, 9E, 9F, and 9G are views illustrating a coil conductor;

FIG. 10 is a view illustrating a cross-sectional configuration taken along line X-X in FIG. 8;

FIG. 11 is a perspective view of an electronic component according to a third embodiment; and

FIG. 12 is a view illustrating a cross-sectional configuration of a stripline.

### DETAILED DESCRIPTION

In the following, preferred embodiments of the present disclosure will be described in detail with reference to the accompanying drawings. Note that, the same or corresponding elements in the description of the drawings are denoted by the same reference signs, and redundant description thereof is omitted.

### First Embodiment

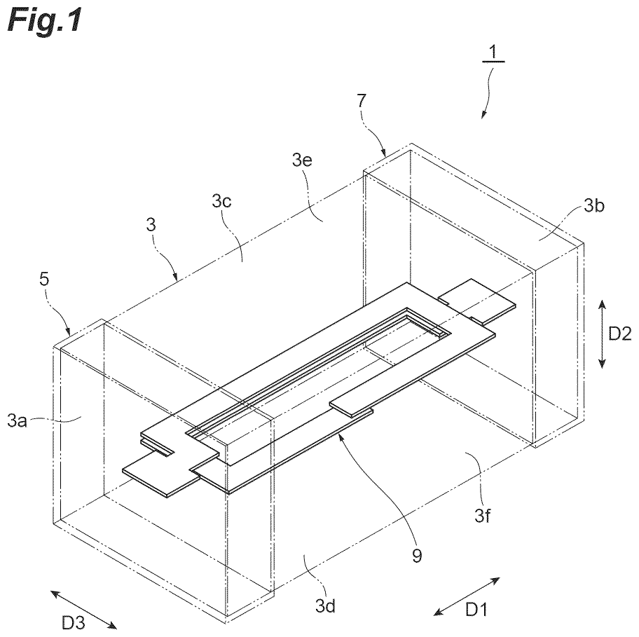

As illustrated in FIG. 1, a coil component (electronic component) 1 according to the first embodiment includes an element body 3, a first external electrode 5 and a second external electrode 7 disposed at both end portions of the element body 3, respectively, and a coil 9.

The element body 3 has a rectangular parallelepiped shape. The rectangular parallelepiped shape includes a shape of a rectangular parallelepiped in which corner parts and ridge line parts are chamfered, or a shape of a rectangular parallelepiped in which corner parts and ridge line parts are rounded. The element body 3 has, as outer surfaces thereof, a pair of end surfaces 3a and 3b facing each other, a pair of main surfaces 3c and 3d facing each other, and a pair of side surfaces 3e and 3f facing each other. A facing direction in which the pair of end surfaces 3a and 3b faces each other is a first direction D1. A facing direction in which the pair of main surfaces 3c and 3d faces each other is a second direction D2. A facing direction in which the pair of side surfaces 3e and 3f faces each other is a third direction D3.

In the present embodiment, the first direction D1 is a longitudinal direction of the element body 3. The second direction D2 is a height direction of the element body 3, and is orthogonal to the first direction D1 and the third direction D3. The third direction D3 is a width direction of the element body 3, and is orthogonal to the second direction D2 and the first direction D1.

The pair of end surfaces 3a and 3b extends in the second direction D2 to connect the pair of main surfaces 3c and 3d. The pair of end surfaces 3a and 3b also extends in the third direction D3 (short side direction of the pair of main surfaces 3c and 3d). The pair of side surfaces 3e and 3f extends in the second direction D2 to connect the pair of main surfaces 3c and 3d. The pair of side surfaces 3e and 3f also extends in the first direction D1 (long side direction of the pair of end surfaces 3a and 3b). When the coil component 1 is implemented on another electronic device (for example, a circuit board, an electronic component, or the like), the main surface 3d can be defined as an implementation surface facing the other electronic device.

The element body 3 is configured by stacking a plurality of dielectric layers (not illustrated). Each dielectric layer is stacked in the second direction D2. That is, the second direction D2 is a stacking direction. The element body 3 has the plurality of stacked dielectric layers. Each dielectric layer is composed of, for example, a sintered body of a ceramic green sheet containing a dielectric material (dielectric ceramic such as BaTiO₃ based, Ba(Ti, Zr)O₃ based, or (Ba, Ca) TiO₃ based). In the actual element body 3, the plurality of dielectric layers is integrated to such an extent that boundaries between the layers cannot be visually recognized.

As illustrated in FIG. 1, the first external electrode 5 is disposed on the end surface 3a side of the element body 3, and the second external electrode 7 is disposed on the end surface 3b side of the element body 3. That is, the first external electrode 5 and the second external electrode 7 are positioned apart from each other in the facing direction of the pair of end surfaces 3a and 3b (first direction D1).

The first external electrode 5 is disposed on the one end surface 3a side. The first external electrode 5 includes five electrode portions including a first electrode portion positioned on the end surface 3a, a second electrode portion positioned on the main surface 3c, a third electrode portion positioned on the main surface 3d, a fourth electrode portion positioned on the side surface 3e, and a fifth electrode portion positioned on the side surface 3f. The first electrode portion, the second electrode portion, the third electrode portion, the fourth electrode portion, and the fifth electrode portion are connected at the ridge line portion of the element body 3, and are electrically connected to each other. The first external electrode 5 is formed on five surfaces of one end surface 3a, the pair of main surfaces 3c and 3d, and the pair of side surfaces 3e and 3f. In the first external electrode 5, the first electrode portion, the second electrode portion, the third electrode portion, the fourth electrode portion, and the fifth electrode portion are integrally formed.

The second external electrode 7 is disposed on the other end surface 3b side. The second external electrode 7 includes five electrode portions including a first electrode portion positioned on the end surface 3b, a second electrode portion positioned on the main surface 3c, a third electrode portion positioned on the main surface 3d, a fourth electrode portion positioned on the side surface 3e, and a fifth electrode portion positioned on the side surface 3f. The first electrode portion, the second electrode portion, the third electrode portion, the fourth electrode portion, and the fifth electrode portion are connected at the ridge line portion of the element body 3, and are electrically connected to each other. The second external electrode 7 is formed on five surfaces of one end surface 3b, the pair of main surfaces 3c and 3d, and the pair of side surfaces 3e and 3f. In the second external electrode 7, the first electrode portion, the second electrode portion, the third electrode portion, the fourth electrode portion, and the fifth electrode portion are integrally formed.

The first external electrode 5 and the second external electrode 7 include a conductive material (for example, Ag or Pd). The first external electrode 5 and the second external electrode 7 are formed as a sintered body of a conductive paste containing a conductive material (for example, Ag powder or Pd powder). A plating layer may be formed on surfaces of the first external electrode 5 and the second external electrode 7. The plating layer is formed through, for example, electroplating. The plating layer have a layer structure including a Cu plating layer, an Ni plating layer, and an Sn plating layer, a layer structure including an Ni plating layer and an Sn plating layer, or the like.

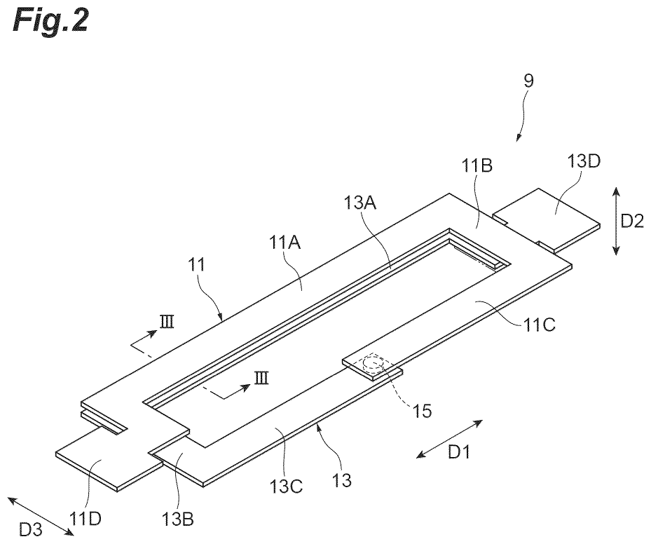

As illustrated in FIG. 2, the coil 9 is configured by electrically connecting a first coil conductor (conductor) 11 and a second coil conductor (conductor) 13. The first coil conductor 11 and the second coil conductor 13 are electrically connected by a connection conductor 15. The first coil conductor 11 constitutes one end portion of the coil 9. The first coil conductor 11 is exposed on the end surface 3a of the element body 3 and is connected to the first external electrode 5 (first electrode portion). The second coil conductor 13 constitutes the other end portion of the coil 9. The second coil conductor 13 is exposed on the end surface 3b of the element body 3 and is connected to the second external electrode 7 (first electrode portion).

The first coil conductor 11, the second coil conductor 13, and the connection conductor 15 are made of a conductive material (for example, Ag, Ni, or Cu) that is usually used as a conductor of a coil. The first coil conductor 11, the second coil conductor 13, and the connection conductor 15 are formed as a sintered body of a conductive paste containing the conductive material.

The first coil conductor 11 includes a first conductor portion 11A, a second conductor portion 11B, a third conductor portion 11C, and a connection portion 11D. The first conductor portion 11A, the second conductor portion 11B, the third conductor portion 11C, and the connection portion 11D are integrally formed (molded).

The first conductor portion 11A extends along the first direction D1. The second conductor portion 11B extends along the third direction D3. The third conductor portion 11C extends along the first direction D1. An end portion of the first conductor portion 11A on the end surface 3b side is connected to an end portion of the second conductor portion 11B on the side surface 3e side. An end portion of the second conductor portion 11B on the side surface 3f side is connected to an end portion of the third conductor portion 11C on the end surface 3b side. In the present embodiment, the length of the first conductor portion 11A is longer than the length of each of the second conductor portion 11B and the third conductor portion 11C. The length of the third conductor portion 11C is longer than the length of the second conductor portion 11B.

The connection portion 11D is connected to an end portion of the first conductor portion 11A on the end surface 3a side. A part of the connection portion 11D is exposed to the end surface 3a. The connection portion 11D is connected to the first external electrode 5 (first electrode portion). Thus, the first coil conductor 11 is electrically connected to the first external electrode 5.

The second coil conductor 13 includes a first conductor portion 13A, a second conductor portion 13B, a third conductor portion 13C, and a connection portion 13D. The first conductor portion 13A, the second conductor portion 13B, the third conductor portion 13C, and the connection portion 13D are integrally formed (molded).

The first conductor portion 13A extends along the first direction D1. The second conductor portion 13B extends along the third direction D3. The third conductor portion 13C extends along the first direction D1. An end portion of the first conductor portion 13A on the end surface 3a side is connected to an end portion of the second conductor portion 13B on the side surface 3e side. An end portion of the second conductor portion 13B on the side surface 3f side is connected to an end portion of the third conductor portion 13C on the end surface 3a side. In the present embodiment, the length of the first conductor portion 13A is longer than the length of each of the second conductor portion 13B and the third conductor portion 13C. The length of the third conductor portion 13C is longer than the length of the second conductor portion 13B.

The connection portion 13D is connected to an end portion of the first conductor portion 13A on the end surface 3b side. A part of the connection portion 13D is exposed to the end surface 3b. The connection portion 13D is connected to the second external electrode 7 (first electrode portion). Thus, the second coil conductor 13 is electrically connected to the second external electrode 7.

The connection conductor 15 connects the third conductor portion 11C of the first coil conductor 11 and the third conductor portion 13C of the second coil conductor 13. The connection conductor 15 is disposed between an end portion of the third conductor portion 11C on the end surface 3a side and an end portion of the third conductor portion 13C on the end surface 3b side. The connection conductor 15 is a through-hole conductor, for example.

The first conductor portion 11A of the first coil conductor 11 and the first conductor portion 13A of the second coil conductor 13 are arranged to face each other in the second direction D2. That is, the first conductor portion 11A and the first conductor portion 13A overlap each other when viewed from the second direction D2. A part (end portion) of the third conductor portion 11C of the first coil conductor 11 and a part (end portion) of the third conductor portion 13C of the second coil conductor 13 are arranged to face each other in the second direction D2. That is, a part of the third conductor portion 11C and a part of the third conductor portion 13C overlap each other when viewed from the second direction D2. The connection conductor 15 is disposed in the overlapping portion.

### <Angle>

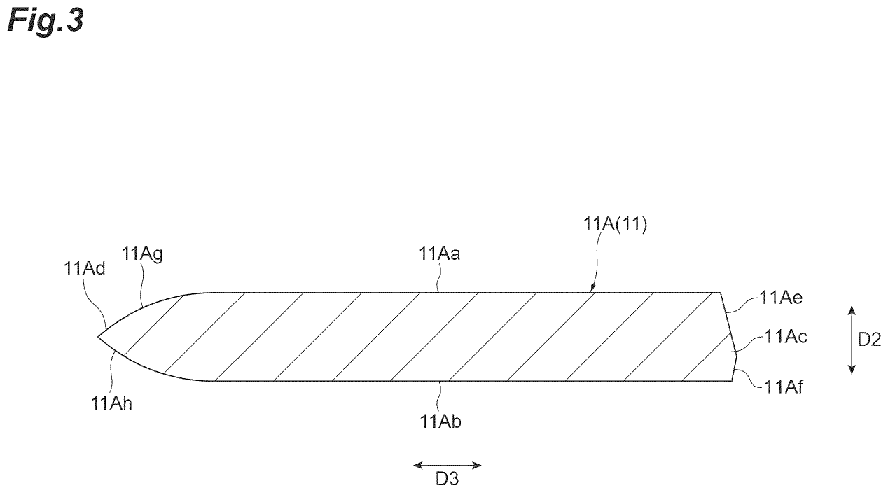

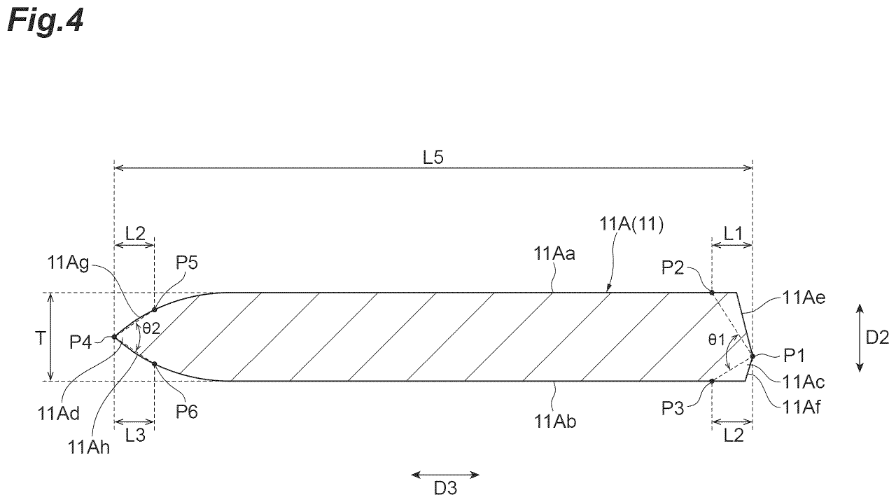

The first coil conductor 11 and the second coil conductor 13 have different angles at both end portions in the width direction in a cross section orthogonal to the extending direction. This will be specifically described with reference to FIGS. 3 and 4. FIGS. 3 and 4 illustrate a cross section of the first conductor portion 11A of the first coil conductor 11. Hereinafter, the angle will be described using the first conductor portion 11A as an example.

FIGS. 3 and 4 illustrate a cross section orthogonal to the extending direction (first direction D1) of the first conductor portion 11A. An orthogonal cross section of the first conductor portion 11A is a cross section along the third direction D3. The thickness direction of the first conductor portion 11A is the second direction D2. The thickness direction of the first conductor portion 11A is the third direction D3. Further, an orthogonal cross section of the second conductor portion 11B is a cross section along the first direction D1. An orthogonal cross section of the third conductor portion 11C is a cross section along the third direction D3.

As illustrated in FIG. 4, the first conductor portion 11A has a first surface 11Aa and a second surface 11Ab. The first surface 11Aa is a surface on the main surface 3c side. The second surface 11Ab is a surface on the main surface 3d side. In the present embodiment, the first surface 11Aa and the second surface 11Ab are flat surfaces. The first surface 11Aa and the second surface 11Ab face each other in the second direction D2. The distance between the first surface 11Aa and the second surface 11Ab corresponds to the thickness of the first conductor portion 11A.

The first conductor portion 11A has a first end portion 11Ac and a second end portion 11Ad. In the present embodiment, in the third conductor portion 11C, the first end portion 11Ac and the second end portion 11Ad have different shapes. The first end portion 11Ac is an end portion on the side surface 3f side. That is, the first end portion 11Ac is an inner end portion (inner edge portion) of the coil 9. The first end portion 11Ac includes a first end portion surface 11Ae and a second end portion surface 11Af. The first end portion surface 11Ae is a surface continuous with the first surface 11Aa. The second end portion surface 11Af is a surface continuous with the second surface 11Ab. That is, the first surface 11Aa and the second surface 11Ab connect the first end portion 11Ac and the second end portion 11Ad.

The second end portion 11Ad is an end portion on the side surface 3e side. That is, the second end portion 11Ad is an outer end portion (outer edge portion) of the coil 9. The second end portion 11Ad includes a first end portion surface 11Ag and a second end portion surface 11Ah. The first end portion surface 11Ag is a surface continuous with the first surface 11Aa. The second end portion surface 11Ah is a surface continuous with the second surface 11Ab. The first end portion surface 11Ag and the second end portion surface 11Ah are curved. The first end portion surface 11Ag and the second end portion surface 11Ah are curved such that the second end portion 11Ad is gradually (continuously) thinned.

Angles of the first end portion 11Ac and the second end portion 11Ad will be described in detail. As illustrated in FIG. 4, the first end portion 11Ac forms a first angle θ1. In the present embodiment, the first angle θ1 is an angle formed by a straight line connecting a first point P1 and a second point P2 (straight line connecting end points) and a straight line connecting the first point P1 and a third point P3. The first point P1 is a point on the outermost end (closest to the side surface 3f) in the third direction D3 in a first end portion 11Cc of the third conductor portion 11C. The first point P1 is an intersection of the first end portion surface 11Ae and the second end portion surface 11Af.

The second point P2 is a point at a position separated from the first point P1 by a distance L1 in the third direction D3 on the first surface 11Aa. The distance L1 is a distance (T/2) of ½ of a thickness T of the first conductor portion 11A (first coil conductor 11). The thickness T is the maximum thickness of the first conductor portion 11A in the second direction D2. The third point P3 is a point at a position separated from the first point P1 by a distance L2 in the third direction D3 on the second surface 11Ab. The distance L2 is a distance (T/2) of ½ of the thickness T of the first conductor portion 11A (first coil conductor 11).

The second end portion 11Ad forms a second angle θ2. In the present embodiment, the second angle θ2 is an angle formed by a straight line connecting a fourth point P4 and a fifth point P5 (straight line connecting end points) and a straight line connecting the fourth point P4 and a sixth point P6. The fourth point P4 is a point on the outermost end (closest to the side surface 3e) in the third direction D3 in a second end portion 11Cd of the first conductor portion 11A. A distance between the first point P1 and the fourth point P4 is a length L3 of the third conductor portion 11C in the width direction (third direction D3).

The fifth point P5 is a point at a position separated from the fourth point P4 by a distance L4 in the third direction D3 on a surface 11Ag. The distance L4 is a distance (T/2) of ½ of the thickness T of the first conductor portion 11A (first coil conductor 11). The sixth point P6 is a point at a position separated from the fourth point P4 by a distance L5 in the third direction D3 on a surface 11Ah. The distance L5 is a distance (T/2) of ½ of the thickness T of the first conductor portion 11A (first coil conductor 11).

In the first conductor portion 11A, the first angle θ1 and the second angle θ2 are different. In the present embodiment, the first angle θ1 is larger than the second angle θ2 (θ1>θ2). In other words, the second angle θ2 is smaller than the first angle θ1 (θ2<θ1). The first angle θ1 is, for example, 60° or more. The second angle θ2 is, for example, less than 60°.

Similarly to the first conductor portion 11A, the first angle θ1 and the second angle θ2 are set also in the second conductor portion 11B and the third conductor portion 11C of the first coil conductor 11. In addition, similarly to the first conductor portion 11A, the first angle θ1 and the second angle θ2 are set also in the first conductor portion 13A, the second conductor portion 13B, and the third conductor portion 13C of the second coil conductor 13.

### <Taper Rate>

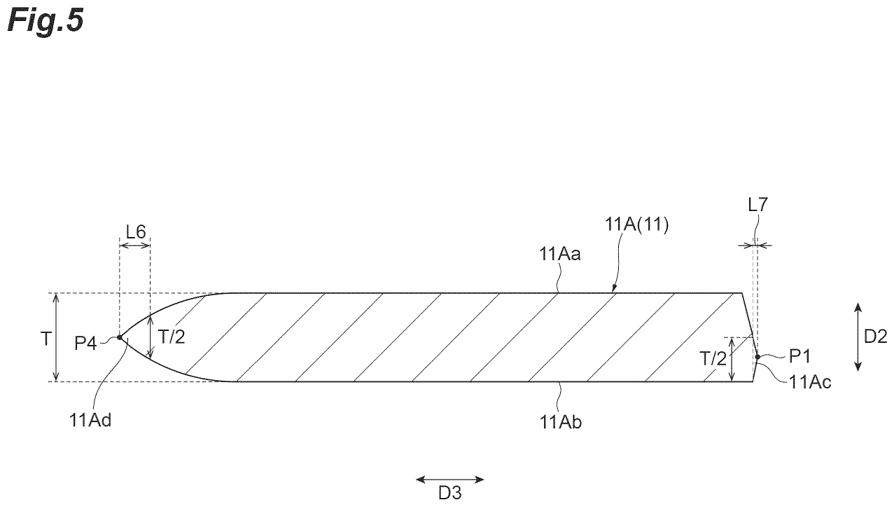

The first coil conductor 11 and the second coil conductor 13 have different taper rates at both end portions in the width direction in a cross section orthogonal to the extending direction. This will be specifically described with reference to FIG. 5. FIG. 5 illustrates a cross section of the first conductor portion 11A of the first coil conductor 11. Hereinafter, the taper rate will be described using the first conductor portion 11A as an example.

Taper rates of the first end portion 11Ac and the second end portion 11Ad will be described in detail. The first end portion 11Ac has a first taper rate TR1. In the present embodiment, the first taper rate TR1 is obtained based on the ratio between the thickness T of the first conductor portion 11A and the distance L7. The distance L7 is a distance (first distance) in the third direction D3 between a position having a thickness of T/2 and the first point P1 in the first end portion 11Ac. The first taper rate TR1(%) is obtained by the following equation.

First taper rate TR1=(T/L7)×100

That is, the first taper rate TR1 is calculated by multiplying a value obtained by dividing the thickness T of the first conductor portion 11A by the distance L7 by 100.

The second end portion 11Ad has a second taper rate TR2. In the present embodiment, the second taper rate TR2 is obtained based on the ratio between the thickness T of the first conductor portion 11A and the distance L6. The distance L6 is a distance (second distance) in the third direction D3 between a position having a thickness of T/2 and the fourth point P4 in the second end portion 11Ad. The second taper rate TR2(%) is obtained by the following equation.

Second taper rate TR2(%)=(T/L6)×100

That is, the second taper rate TR2 is calculated by multiplying a value obtained by dividing the thickness T of the first conductor portion 11A by the distance L6 by 100.

In the first conductor portion 11A, the first taper rate TR1 and the second taper rate TR2 are different. In the present embodiment, the first taper rate TR1 is larger than the second taper rate TR2 (TR1>TR2). In other words, the second taper rate TR2 is smaller than the first taper rate TR1 (TR2<TR1). The first taper rate TR1 is, for example, 55% or more. The second taper rate TR2 is, for example, less than 55%.

Similarly to the first conductor portion 11A, the first taper rate TR1 and the second taper rate TR2 are set also in the second conductor portion 11B and the third conductor portion 11C of the first coil conductor 11. In addition, similarly to the first conductor portion 11A, the first taper rate TR1 and the second taper rate TR2 are set also in the first conductor portion 13A, the second conductor portion 13B, and the third conductor portion 13C of the second coil conductor 13.

In the coil component 1, when a current flows through the first coil conductor 11 and the second coil conductor 13, the current distribution is higher in the inner edge portion of the first coil conductor 11 and the second coil conductor 13 than in the outer edge portion. That is, if the first conductor portion 11A of the first coil conductor 11 is described as an example, the current distribution is higher in the first end portion 11Ac than in the second end portion 11Ad. It can also be said that deviation occurs in the current distribution in the first coil conductor 11. In the first conductor portion 11A, the electric field strength is higher in the first end portion 11Ac than in the second end portion 11Ad.

As described above, in the coil component 1 according to the present embodiment, the first coil conductor 11 and the second coil conductor 13 have different angles at both end portions in the width direction in a cross section orthogonal to the extending direction. The first coil conductor 11 and the second coil conductor 13 have a first end portion and a second end portion. The first end portion forms a first angle θ1, and the second end portion forms a second angle θ2. In the first coil conductor 11 and the second coil conductor 13, the first angle θ1 and the second angle θ2 are different. In the present embodiment, the first angle θ1 is larger than the second angle θ2 (θ1>θ2). Further, the first end portion has a first taper rate TR1, and the second end portion has a second taper rate TR2. In the first coil conductor 11 and the second coil conductor 13, the first taper rate TR1 and the second taper rate TR2 are different. In the present embodiment, the first taper rate TR1 is larger than the second taper rate TR2 (TR1>TR2). In this configuration, a high Q factor can be obtained at the first end portion.

In the coil component 1 according to the present embodiment, a part of the first coil conductor 11 and a part of the second coil conductor 13 overlap each other. In this configuration, by making the second angle θ2 of the second end portion smaller than the first angle θ1 of the first end portion, the distance (interval in the second direction D2) between the second end portion of the first coil conductor 11 and the second end portion of the second coil conductor 13 can be lengthened, so that the stray capacitance between the first coil conductor 11 and the second coil conductor 13 can be reduced. As a result, in the coil component 1, the self-resonant frequency can be increased.

In the coil component 1 according to the present embodiment, the first angle θ1 is 60° or more. The second angle θ2 is less than 60°. Further, the first taper rate TR1 is 55% or more. The second taper rate TR2 is less than 55%. In these configurations, the self-resonant frequency can be increased while a high Q factor is obtained in the first coil conductor 11 and the second coil conductor 13.

### Second Embodiment

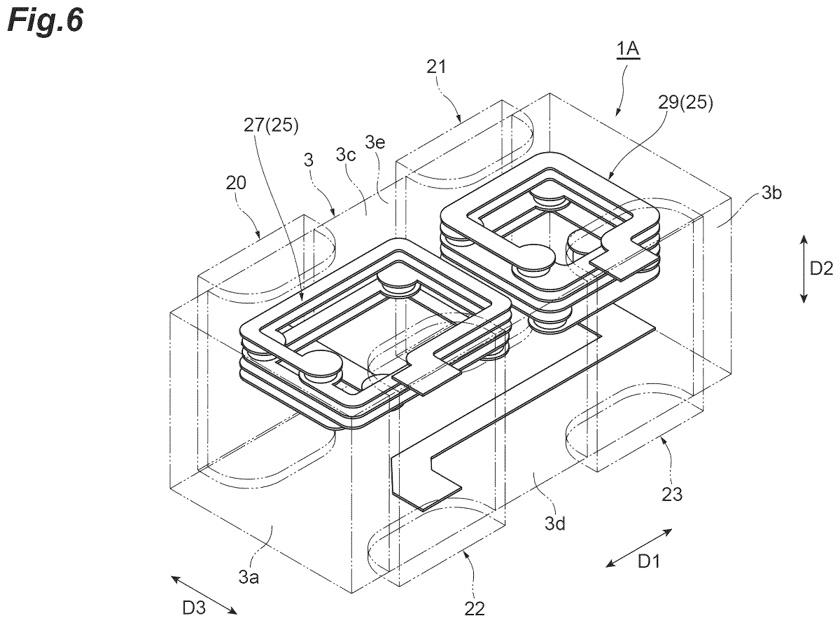

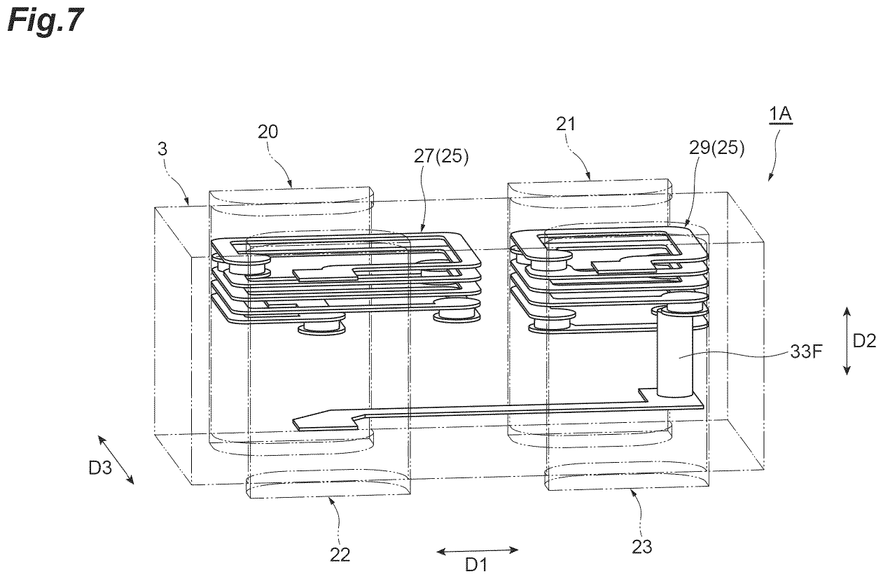

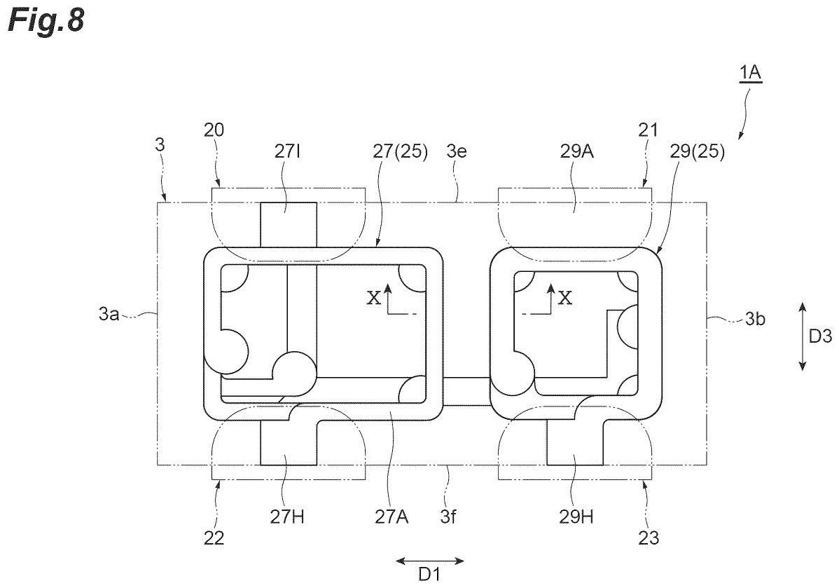

Next, a second embodiment will be described. FIG. 6 is a perspective view of a coil component according to the second embodiment. FIG. 7 is a perspective view of the coil component illustrated in FIG. 6. FIG. 8 is a view of the coil component illustrated in FIG. 6 as viewed from a main surface side.

As shown in FIGS. 6 to 8, the coil component 1A includes an element body 3, a first external electrode 20, a second external electrode 21, a third external electrode 22, and a fourth external electrode 23 disposed on the element body 3, and a coil 25.

The first external electrode 20 and the second external electrode 21 are disposed on the side surface 3e side of the element body 3. The first external electrode 20 and the second external electrode 21 are formed so as to cover a part of the side surface 3e along a second direction D2 of the element body 3, and are formed on a part of the main surface 3c and a part of the main surface 3d. The first external electrode 20 and the second external electrode 21 are disposed apart from each other in a first direction D1. The first external electrode 20 is positioned on the end surface 3a side, and the second external electrode 21 is positioned on the end surface 3b side.

The third external electrode 22 and the fourth external electrode 23 are disposed on the side surface 3f side of the element body 3. The third external electrode 22 and the fourth external electrode 23 are formed so as to cover a part of the side surface 3f along the second direction D2 of the element body 3, and are formed on a part of the main surface 3c and a part of the main surface 3d. The third external electrode 22 and the fourth external electrode 23 are disposed apart from each other in the first direction D1. The third external electrode 22 is positioned on the end surface 3a side, and the fourth external electrode 23 is positioned on the end surface 3b side.

The first external electrode 20, the second external electrode 21, the third external electrode 22, and the fourth external electrode 23 contain a conductive material (for example, Ag or Pd). The first external electrode 20, the second external electrode 21, the third external electrode 22, and the fourth external electrode 23 are formed as a sintered body of a conductive paste containing a conductive material (for example, Ag powder or Pd powder). A plating layer may be formed on surfaces of the first external electrode 20, the second external electrode 21, the third external electrode 22, and the fourth external electrode 23. The plating layer is formed through, for example, electroplating. The plating layer have a layer structure including a Cu plating layer, an Ni plating layer, and an Sn plating layer, a layer structure including an Ni plating layer and an Sn plating layer, or the like.

The coil 25 is configured by electrically connecting a first coil 27 and a second coil 29. The first coil 27 and the second coil 29 are electrically connected by the third external electrode 22. The first coil 27 and the second coil 29 are arranged side by side at a distance in the first direction D1 in the element body 3. The first coil 27 is positioned on the end surface 3a side, and the second coil 29 is positioned on the end surface 3b side.

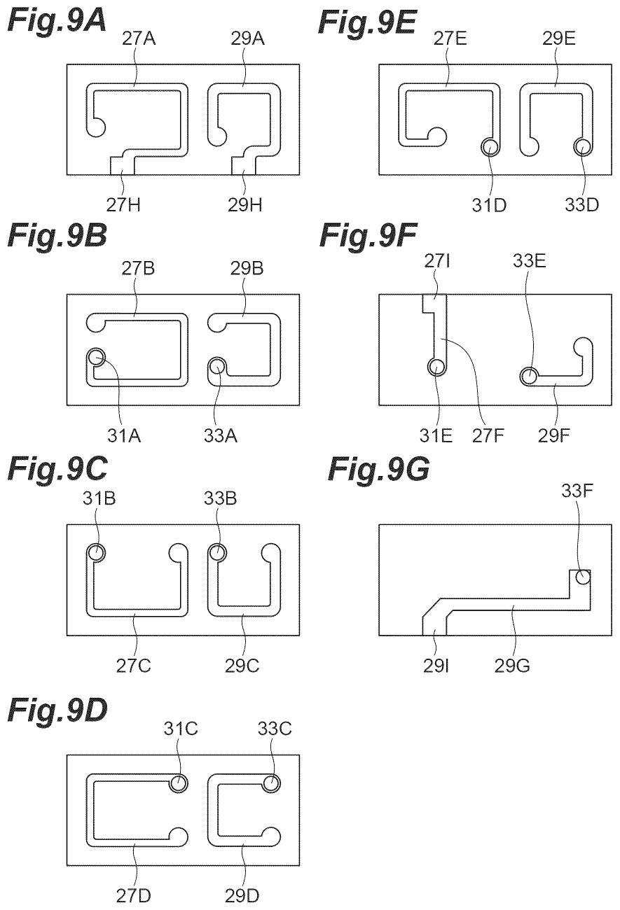

As illustrated in FIGS. 9A, 9B, 9C, 9D, 9E, and 9F, the first coil 27 is configured by electrically connecting a first coil conductor 27A, a second coil conductor 27B, a third coil conductor 27C, a fourth coil conductor 27D, a fifth coil conductor 27E, and a sixth coil conductor 27F. The first coil conductor 27A and the second coil conductor 27B are electrically connected by a connection conductor (through-hole conductor) 31A. The second coil conductor 27B and the third coil conductor 27C are electrically connected by a connection conductor 31B. The third coil conductor 27C and the fourth coil conductor 27D are electrically connected by a connection conductor 31C. The fourth coil conductor 27D and the fifth coil conductor 27E are electrically connected by a connection conductor 31D. The fifth coil conductor 27E and the sixth coil conductor 27F are electrically connected by a connection conductor 31E.

The first coil conductor 27A constitutes one end portion of the first coil 27. The first coil conductor 27A is exposed to the side surface 3f of the element body 3 and connected to the third external electrode 22. Specifically, the first coil conductor 27A has a connection portion 27H, and the connection portion 27H is connected to the third external electrode 22. The sixth coil conductor 27F constitutes the other end portion of the first coil 27. The sixth coil conductor 27F is exposed to the side surface 3e of the element body 3 and connected to the first external electrode 20. Specifically, the sixth coil conductor 27F has a connection portion 27I, and the connection portion 27I is connected to the first external electrode 20.

As illustrated in FIGS. 9A, 9B, 9C, 9D, 9E, and 9F, the second coil 29 is configured by electrically connecting a first coil conductor 29A, a second coil conductor 29B, a third coil conductor 29C, a fourth coil conductor 29D, a fifth coil conductor 29E, and a sixth coil conductor 29F. The first coil conductor 29A and the second coil conductor 29B are electrically connected by a connection conductor (through-hole conductor) 33A. The second coil conductor 29B and the third coil conductor 29C are electrically connected by a connection conductor 33B. The third coil conductor 29C and the fourth coil conductor 29D are electrically connected by the connection conductor 33C. The fourth coil conductor 29D and the fifth coil conductor 29E are electrically connected by a connection conductor 33D. The fifth coil conductor 29E and the sixth coil conductor 29F are electrically connected by a connection conductor 33E.

The first coil conductor 29A constitutes one end portion of the second coil 29. The first coil conductor 29A is exposed to the side surface 3f of the element body 3 and connected to the fourth external electrode 23. Specifically, the first coil conductor 29A has a connection portion 29H, and the connection portion 29H is connected to the fourth external electrode 23. The sixth coil conductor 29F constitutes the other end portion of the second coil 29. As illustrated in FIG. 9G, the sixth coil conductor 27F is electrically connected to the third external electrode 22 via a connection conductor 29G. The sixth coil conductor 29F and the connection conductor 29G are electrically connected by a connection conductor 33F (through-hole conductor). The connection conductor 33F extends along the second direction D2. The connection conductor 29G has a connection portion 29I, and the connection portion 29I is connected to the third external electrode 22.

As illustrated in FIG. 9A, the first coil conductor 27A of the first coil 27 and the first coil conductor 29A of the second coil 29 are disposed at the same position (layer) in the second direction D2. As illustrated in FIG. 9B, the second coil conductor 27B of the first coil 27 and the second coil conductor 29B of the second coil 29 are disposed at the same position (layer) in the second direction D2. As illustrated in FIG. 9C, the third coil conductor 27C of the first coil 27 and the third coil conductor 29C of the second coil 29 are disposed at the same position (layer) in the second direction D2.

As illustrated in FIG. 9D, the fourth coil conductor 27D of the first coil 27 and the fourth coil conductor 29D of the second coil 29 are disposed at the same position (layer) in the second direction D2. As illustrated in FIG. 9E, the fifth coil conductor 27E of the first coil 27 and the fifth coil conductor 29E of the second coil 29 are disposed at the same position (layer) in the second direction D2. As illustrated in FIG. 9F, the sixth coil conductor 27F of the first coil 27 and the sixth coil conductor 29F of the second coil 29 are disposed at the same position (layer) in the second direction D2.

### <Angle>

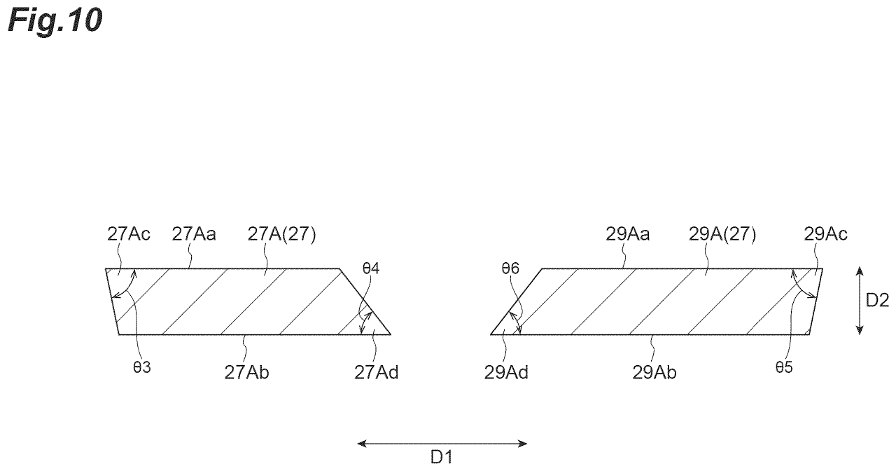

The first coil conductor 27A, the second coil conductor 27B, the third coil conductor 27C, the fourth coil conductor 27D, the fifth coil conductor 27E, and the sixth coil conductor 27F have different angles at both end portions in the width direction in a cross section orthogonal to the extending direction. In addition, the first coil conductor 29A, the second coil conductor 29B, the third coil conductor 29C, the fourth coil conductor 29D, the fifth coil conductor 29E, and the sixth coil conductor 29F have different angles at both end portions in the width direction in a cross section orthogonal to the extending direction. This will be specifically described with reference to FIG. 10. FIG. 10 illustrates a cross section of each of the first coil conductor 27A and the first coil conductor 29A. Hereinafter, the angle will be described using the first coil conductor 27A and the first coil conductor 29A as an example.

FIG. 10 illustrates a cross section orthogonal to the extending direction (third direction D3) of the first coil conductor 27A and the first coil conductor 29A. An orthogonal cross section of the first coil conductor 27A and the first coil conductor 29A is a cross section along the first direction D1. In the example illustrated in FIG. 10, the thickness direction of the first coil conductor 27A and the first coil conductor 29A is the second direction D2. The width direction of the first coil conductor 27A and the first coil conductor 29A is the first direction D1.

The first coil conductor 27A has a first surface 27Aa and a second surface 27Ab. The first surface 27Aa is a surface on the main surface 3c side. The second surface 27Ab is a surface on the main surface 3d side. The distance between the first surface 27Aa and the second surface 27Ab corresponds to the thickness of the first coil conductor 27A.

The first coil conductor 27A has a first end portion 27Ac and a second end portion 27Ad. In the present embodiment, the first end portion 27Ac is an end portion on the end surface 3a side. The first end portion 27Ac is an inner end portion (inner edge portion) of the first coil 27. The second end portion 27Ad is an end portion on the end surface 3b side. The second end portion 27Ad is an outer end portion (outer edge portion) of the first coil 27.

Angles of the first end portion 27Ac and the second end portion 27Ad will be described in detail. The first end portion 27Ac forms a first angle θ3. The second end portion 27Ad forms a second angle θ4. In the first coil conductor 27A, the first angle θ3 and the second angle θ4 are different. In the present embodiment, the first angle θ3 is larger than the second angle θ4 (θ3>θ4). In other words, the second angle θ4 is smaller than the first angle θ3 (θ4<θ3). The first angle θ3 is, for example, 60° or more. The second angle θ4 is, for example, less than 60°.

Similarly to the first coil conductor 27A, the first angle θ3 and the second angle θ4 are set also in the second coil conductor 27B, the third coil conductor 27C, the fourth coil conductor 27D, the fifth coil conductor 27E, and the sixth coil conductor 27F of the first coil 27.

The first coil conductor 29A has a first surface 29Aa and a second surface 29Ab. The first surface 29Aa is a surface on the main surface 3c side. The second surface 29Ab is a surface on the main surface 3d side. The distance between the first surface 29Aa and the second surface 29Ab corresponds to the thickness of the first coil conductor 29A.

The first coil conductor 29A has a first end portion 29Ac and a second end portion 29Ad. In the present embodiment, the first end portion 29Ac is an end portion on the end surface 3b side. The first end portion 29Ac is an inner end portion (inner edge portion) of the second coil 29. The second end portion 29Ad is an end portion on the end surface 3a side. The second end portion 29Ad is an outer end portion (outer edge portion) of the second coil 29.

Angles of the first end portion 29Ac and the second end portion 29Ad will be described in detail. The first end portion 29Ac forms a first angle θ5. The second end portion 29Ad forms a second angle θ6.

In the first coil conductor 29A, the first angle θ5 and the second angle θ6 are different. In the present embodiment, the first angle θ5 is larger than the second angle θ6 (θ5>θ6). In other words, the second angle θ6 is smaller than the first angle θ5 (θ6<θ5). The first angle θ5 is, for example, 60° or more. The second angle θ6 is, for example, less than 60°.

Similarly to the first coil conductor 29A, the first angle θ5 and the second angle θ6 are set also in the second coil conductor 29B, the third coil conductor 29C, the fourth coil conductor 29D, the fifth coil conductor 29E, and the sixth coil conductor 29F of the second coil 29.

### <Taper Rate>

The first coil conductor 27A has different taper rates at both end portions in the width direction in a cross section orthogonal to the extending direction. The first end portion 27Ac has a first taper rate TR3. The second end portion 27Ad has a second taper rate TR4. The first taper rate TR3 and the second taper rate TR4 can be obtained in the same manner as in the first embodiment.

In the first coil conductor 27A, the first taper rate TR3 and the second taper rate TR4 are different. In the present embodiment, the first taper rate TR3 is larger than the second taper rate TR4 (TR3>TR4). In other words, the second taper rate TR4 is smaller than the first taper rate TR3 (TR4<TR3). The first taper rate TR3 is, for example, 55% or more. The second taper rate TR4 is, for example, less than 55%.

Similarly to the first coil conductor 27A, the first taper rate TR3 and the second taper rate TR4 are set also in the second coil conductor 27B, the third coil conductor 27C, the fourth coil conductor 27D, the fifth coil conductor 27E, and the sixth coil conductor 27F of the first coil 27.

The first coil conductor 29A has different taper rates at both end portions in the width direction in a cross section orthogonal to the extending direction. The first end portion 29Ac has a first taper rate TR5. The second end portion 29Ad has a second taper rate TR6. The first taper rate TR5 and the second taper rate TR6 can be obtained in the same manner as in the first embodiment.

In the first coil conductor 29A, the first taper rate TR5 and the second taper rate TR6 are different. In the present embodiment, the first taper rate TR5 is larger than the second taper rate TR6 (TR5>TR6). In other words, the second taper rate TR6 is smaller than the first taper rate TR5 (TR6<TR5). The first taper rate TR5 is, for example, 55% or more. The second taper rate TR6 is, for example, less than 55%.

Similarly to the first coil conductor 29A, the first taper rate TR5 and the second taper rate TR6 are set also in the second coil conductor 29B, the third coil conductor 29C, the fourth coil conductor 29D, the fifth coil conductor 29E, and the sixth coil conductor 29F of the second coil 29.

The second end portion 27Ad of the first coil conductor 27A and the second end portion 29Ad of the first coil conductor 29A are arranged to face (be adjacent to) each other in the first direction D1. The first angle θ3 of the first end portion 27Ac of the first coil conductor 27A and the first angle θ5 of the first end portion 29Ac of the first coil conductor 29A may be the same or different. The second angle θ4 of the second end portion 27Ad of the first coil conductor 27A and the second angle θ6 of the second end portion 29Ad of the first coil conductor 29A may be the same or different. The first taper rate TR3 of the first end portion 27Ac of the first coil conductor 27A and the first taper rate TR5 of the first end portion 29Ac of the first coil conductor 29A may be the same or different. The second taper rate TR4 of the second end portion 27Ad of the first coil conductor 27A and the second taper rate TR6 of the second end portion 29Ad of the first coil conductor 29A may be the same or different.

In the coil component 1A, during energization, the current distribution is higher in the inner edge portion of the first coil conductor 27A, the second coil conductor 27B, the third coil conductor 27C, the fourth coil conductor 27D, the fifth coil conductor 27E, and the sixth coil conductor 27F of the first coil 27 than in the outer edge portion. That is, if the first coil conductor 27A is described as an example, the current distribution is higher in the first end portion 27Ac than in the second end portion 27Ad. It can also be said that deviation occurs in the current distribution in the first coil conductor 27A. In the first coil conductor 27A, the electric field strength is higher in the first end portion 27Ac than in the second end portion 27Ad.

In addition, in the coil component 1A, during energization, the current distribution is higher in the inner edge portion of the first coil conductor 29A, the second coil conductor 29B, the third coil conductor 29C, the fourth coil conductor 29D, the fifth coil conductor 29E, and the sixth coil conductor 29F of the second coil 29 than in the outer edge portion. That is, if the first coil conductor 29A is described as an example, the current distribution is higher in the first end portion 29Ac than in the second end portion 29Ad. It can also be said that deviation occurs in the current distribution in the first coil conductor 29A. In the first coil conductor 29A, the electric field strength is higher in the first end portion 29Ac than in the second end portion 29Ad.

As described above, in the coil component 1A according to the present embodiment, the first coil conductor 27A, the second coil conductor 27B, the third coil conductor 27C, the fourth coil conductor 27D, the fifth coil conductor 27E, and the sixth coil conductor 27F constituting the first coil 27 have different angles at both end portions in the width direction in the cross section orthogonal to the extending direction. The first coil conductor 27A, the second coil conductor 27B, the third coil conductor 27C, the fourth coil conductor 27D, the fifth coil conductor 27E, and the sixth coil conductor 27F have a first end portion and a second end portion. The first end portion forms a first angle θ3, and the second end portion forms a second angle θ4. In the first coil conductor 27A, the second coil conductor 27B, the third coil conductor 27C, the fourth coil conductor 27D, the fifth coil conductor 27E, and the sixth coil conductor 27F, the first angle θ3 and the second angle θ4 are different. In the present embodiment, the first angle θ3 is larger than the second angle θ4 (θ3>θ4). Further, the first end portion has a first taper rate TR3, and the second end portion has a second taper rate TR4. In the first coil conductor 27A, the second coil conductor 27B, the third coil conductor 27C, the fourth coil conductor 27D, the fifth coil conductor 27E, and the sixth coil conductor 27F, the first taper rate TR3 and the second taper rate TR4 are different. In the present embodiment, the first taper rate TR3 is larger than the second taper rate TR4 (TR3>TR4). According to this configuration, in the first coil 27, a high Q factor can be obtained at the first end portion. Similarly, a high Q factor can be obtained also for the second coil 29.

In the coil component 1A according to the present embodiment, adjacent coil conductors overlap each other in the first coil conductor 27A, the second coil conductor 27B, the third coil conductor 27C, the fourth coil conductor 27D, the fifth coil conductor 27E, and the sixth coil conductor 27F of the first coil 27. In this configuration, by making the second angle θ4 of the second end portion smaller than the first angle θ3 of the first end portion, the distance between the second end portions of the coil conductors adjacent to each other in the second direction D2 (interval between the second directions D2) can be increased, so that the stray capacitance between the coil conductors adjacent to each other can be reduced. Similarly, the stray capacitance of the second coil 29 can be reduced. As a result, in the coil component 1A, the self-resonant frequency can be increased.

In addition, in the coil component 1A, the coil conductor of the first coil 27 and the coil conductor of the second coil 29 are arranged such that the second end portions face each other. As a result, the stray capacitance can be reduced in the adjacent coil conductors. In addition, it is possible to suppress magnetic coupling in the adjacent coil conductors. As a result, in the coil component 1A, the self-resonant frequency can be increased.

### Third Embodiment

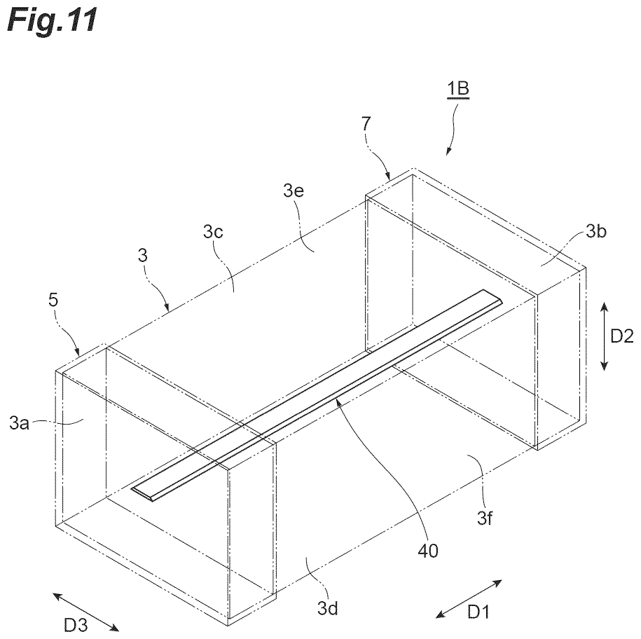

Next, a third embodiment will be described. FIG. 11 is a perspective view of an electronic component according to the third embodiment. As illustrated in FIG. 11, an electronic component 1B includes an element body 3, a first external electrode 5 and a second external electrode 7 disposed at both end portions of the element body 3, respectively, and a stripline (conductor) 40. The electronic component 1B is a stripline-type filter.

The stripline 40 extends along a first direction D1. One end portion of the stripline 40 is exposed on an end surface 3a of the element body 3 and is connected to the first external electrode 5 (first electrode portion). The other end portion of the stripline 40 is exposed on an end surface 3b of the element body 3 and is connected to the second external electrode 7 (first electrode portion).

### <Angle>

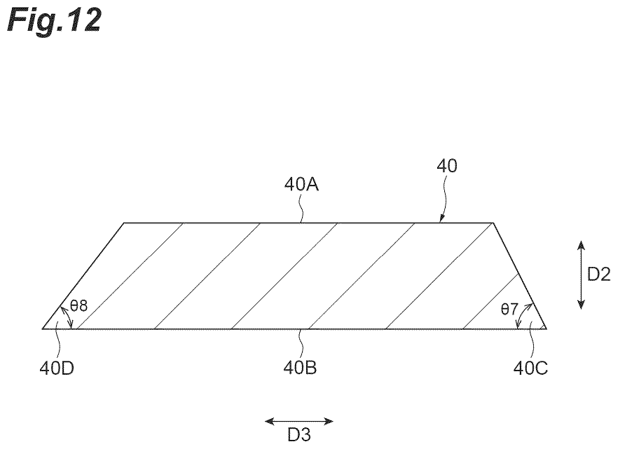

The stripline 40 has different angles at both end portions in the width direction in a cross section orthogonal to the extending direction. FIG. 12 is a view illustrating a cross-sectional configuration of a stripline. FIG. 12 illustrates a cross section orthogonal to the extending direction (first direction D1) of the stripline 40. The orthogonal cross section in the stripline 40 is a cross section along a third direction D3. In the present embodiment, the cross section of the stripline 40 has a trapezoidal shape. The thickness direction of the stripline 40 is the second direction D2. The width direction of the stripline 40 is the third direction D3. The stripline 40 has a first surface 40A and a second surface 40B.

The first surface 40A is a surface on a main surface 3c side. The second surface 40B is a surface on a main surface 3d side. The distance between the first surface 40A and the second surface 40B corresponds to the thickness of the stripline 40.

The first conductor portion 11A has a first end portion 40C and a second end portion 40D. In the present embodiment, the first end portion 40C is an end portion on the side surface 3f side. The second end portion 40D is an end portion on the side surface 3e side.

Angles of the first end portion 40C and the second end portion 40D will be described in detail. The first end portion 40C forms a first angle θ7. The second end portion 40D forms a second angle θ8.

In the stripline 40, the first angle θ7 and the second angle θ8 are different. In the present embodiment, the first angle θ7 is larger than the second angle θ8 (θ7>θ8). In other words, the second angle θ8 is smaller than the first angle θ7 (θ8<θ7). The first angle θ7 is, for example, 60° or more. The second angle θ8 is, for example, less than 60°.

### <Taper Rate>

The stripline 40 has different taper rates at both end portions in the width direction in a cross section orthogonal to the extending direction. The first end portion 40C has a first taper rate TR7. The second end portion 40D has a second taper rate TR8. The first taper rate TR7 and the second taper rate TR8 can be obtained in the same manner as in the first embodiment.

In the stripline 40, the first taper rate TR7 and the second taper rate TR8 are different. In the present embodiment, the first taper rate TR7 is larger than the second taper rate TR8 (TR7>TR8). In other words, the second taper rate TR8 is smaller than the first taper rate TR7 (TR8<TR7). The first taper rate TR7 is, for example, 55% or more. The second taper rate TR8 is, for example, less than 55%.

As described above, in the electronic component 1B according to the present embodiment, the stripline 40 has different angles at both end portions in the width direction in a cross section orthogonal to the extending direction. The stripline 40 has a first end portion 40C and a second end portion 40D. The first end portion 40C forms the first angle θ7, and the second end portion 40D forms the second angle θ8. In the stripline 40, the first angle θ7 and the second angle θ8 are different. In the electronic component 1B, the first angle θ7 is larger than the second angle θ8. Further, the first end portion 40C has the first taper rate TR7, and the second end portion 40D has the second taper rate TR8. In the stripline 40, the first taper rate TR7 and the second taper rate TR8 are different. In the present embodiment, the first taper rate TR7 is larger than the second taper rate TR8 (TR7>TR8). In this configuration, a high Q factor can be obtained at the first end portion 40C.

In the electronic component 1B according to the present embodiment, the second angle θ8 of the second end portion 40D is smaller than the first angle θ7 of the first end portion 40C (θ8<θ7). In addition, the second taper rate TR8 of the second end portion 40D is smaller than the first taper rate TR7 of the first end portion 40C (TR8<TR7). In this configuration, since a distance to another component (such as an external electrode) can be increased, stray capacitance between the stripline 40 and another component can be reduced. As a result, in the electronic component 1B, the self-resonant frequency can be increased.

Although the embodiments of the present disclosure have been described in the foregoing, the present disclosure is not necessarily limited to the above-described embodiments, and various modifications can be made without departing from the gist thereof.

In the above embodiments, each of the angle and the taper rate is set for the conductor, but at least one of the angle and the taper rate may be set.

In addition to the above embodiments, each dielectric layer constituting the element body 3 may contain a plurality of metal magnetic particles. The metal magnetic particles include a soft magnetic alloy (soft magnetic material). The soft magnetic alloy is, for example, an Fe—Si-based alloy. When the soft magnetic alloy is a Fe—Si-based alloy, the soft magnetic alloy may contain P. The soft magnetic alloy may be, for example, a Fe—Ni—Si-M-based alloy. “M” contains one or more elements selected from Co, Cr, Mn, P, Ti, Zr, Hf, Nb, Ta, Mo, Mg, Ca, Sr, Ba, Zn, B, Al, and rare earth elements.

In the dielectric layer, the metal magnetic particles are bonded to each other. The bonding between the metal magnetic particles is realized by, for example, bonding between oxide films formed on surfaces of the metal magnetic particles. In the dielectric layer, the metal magnetic particles are electrically insulated from each other by bonding between the oxide films. The thickness of the oxide film is, for example, 5 nm or more and 60 nm or less. The oxide film may include one or a plurality of layers.

The element body 3 may contain a resin. The resin is present between the plurality of metal magnetic particles. The resin is a resin having an electrical insulation property (insulating resin). The insulating resin includes, for example, a silicone resin, a phenol resin, an acrylic resin, or an epoxy resin.

In the embodiments described above, in the coil component 1 and the electronic component 1B, an embodiment in which each of the first external electrode 5 and the second external electrode 7 has the first electrode portion, the second electrode portion, the third electrode portion, the fourth electrode portion, and the fifth electrode portion has been described as an example. However, the shapes of the first external electrode 5 and the second external electrode 7 are not limited thereto. In addition, in the coil component 1A, an embodiment in which each of the first external electrode 20, the second external electrode 21, the third external electrode 22, and the fourth external electrode 23 is formed so as to cover a part of the side surfaces 3e and 3f along the second direction D2 of the element body 3, and is formed on a part of the main surface 3c and a part of the main surface 3d has been described as an example. However, the shapes of the first external electrode 20, the second external electrode 21, the third external electrode 22, and the fourth external electrode 23 are not limited thereto.

In the above embodiments, the number and shape of the coil conductors constituting the coils are not limited.

In the first embodiment, an embodiment in which the first surface 10Aa and the second surface 10Ab are flat surfaces has been described as an example. However, at least one of the first surface and the second surface may be a curved surface.

What is claimed is:

1. An electronic component comprising:
an element body; and
a conductor disposed in the element body, wherein
the conductor has, in a cross section orthogonal to an extending direction of the conductor, a first end portion and a second end portion in a width direction viewed from the extending direction,
the first end portion forms a first angle,
the second end portion forms a second angle, and
the first angle and the second angle are different.

2. The electronic component according to claim 1, wherein the first angle is larger than the second angle.

3. The electronic component according to claim 1, wherein the first angle is 60° or more.

4. The electronic component according to claim 1, wherein the second angle is less than 60°.

5. The electronic component according to claim 1, wherein, when a current flows through the conductor, a current distribution at the first end portion is higher than a current distribution at the second end portion.

6. The electronic component according to claim 2, wherein
the conductor has a first surface and a second surface connecting the first end portion and the second end portion, and
at least one of the first surface and the second surface is curved.

7. An electronic component comprising:
an element body; and
a conductor disposed in the element body, wherein
the conductor has, in a cross section orthogonal to an extending direction of the conductor, a first end portion and a second end portion in a width direction viewed from the extending direction,
the first end portion has a first taper rate set based on a ratio between a thickness of the conductor and a first distance from an end of the first end portion to a position at a distance of ½ of the thickness in the width direction,
the second end portion has a second taper rate set based on a ratio between the thickness of the conductor and a second distance from an end of the second end portion to a position at a distance of ½ of the thickness in the width direction, and
the first taper rate and the second taper rate are different.

8. The electronic component according to claim 7, wherein the first taper rate is larger than the second taper rate.

9. The electronic component according to claim 7, wherein the first taper rate is 55% or more.

10. The electronic component according to claim 7, wherein the second taper rate is less than 55%.

11. The electronic component according to claim 7, wherein, when a current flows through the conductor, a current distribution at the first end portion is higher than a current distribution at the second end portion.
